(19) United States
(12) Patent Application Publication
(10) Pub. No.: US 2026/0354312 A1
(43) Pub. Date: Nov. 12, 2026

(54) A NEW GRAFTED SEEDLING PRODUCTION METHOD THAT REDUCES SEEDLING LOSSES

(71) Applicant: Salih SIZER, Kayapinar, Diyarbakir (TR)

(72) Inventor: Salih SIZER, Kayapinar, Diyarbakir (TR)

(21) Appl. No.: 19/489,653

(22) PCT Filed: Feb. 28, 2025
(86) PCT No.: PCT/TR2025/050186

§ 371 Date: Dec. 3, 2025

(30) Foreign Application Priority Data
Mar. 12, 2024 (TR) 2024/002950

(51) Int. Cl. A01G 2/35; A01G 17/00

(52) U.S. Cl. CPC A01G 2/35; A01G 17/005

(57) ABSTRACT

A grafting method for the production of grafted seedlings in agriculture without the need for large areas of land, in a shorter period of time, with a high grafting success rate and quality. In particular, a waste-free grafted seedling production method prevents seedling losses by producing grafted seedlings without cutting and without disturbing the crown/root balance, especially in the field of fruit growing and ornamental plants.

### FIELD OF THE INVENTION

The present invention relates to a new grafting method for the production of grafted seedling in agriculture without the need for large areas of land, in a shorter period of time, with a high grafting success rate and quality.

In particular, the present invention relates to a grafted seedling production method that prevents seedling losses by producing grafted seedlings without cutting and without disturbing the crown/root balance, especially in the field of fruit growing and ornamental plants.

### STATE OF THE ART

The use of rootstocks is preferred for many reasons such as the fact that fruit trees often have to be grown in climate and soil conditions that are not suitable for them, the desire to control development, shortening the period of youth sterility, increasing fruit quality and yield, and facilitating the control of diseases and pests.

In the state of the art, clonal production method is widely used for seedling production and propagation. In this method, an example schematic view of which is given in FIG. 1, branches of superior rootstocks are cut to obtain 10 cm cuttings. Then, the parts of these cuttings closest to the soil are immersed in rooting hormone and transferred to the rooting medium. In order for rooting to occur, they are kept in a suitable humidity and temperature environment for rooting. These rooted cuttings have all the characteristics of the rootstock. These rooted cuttings are placed in a greenhouse environment to promote sprouting, thereby forming a true rootstock with both roots and shoots. Once these rootstocks are formed, they are transferred to the field or pot environment, where they are maintained until they reach the grafting thickness. After one year,, the rootstocks that have reached the required grafting thickness are grafted, and the top of the graft is cut off. The stagnant grafted buds awaken in the spring as the weather warms up and shoots begin to form. The necessary maintenance of the grafted seedlings is carried out during the season and they are made ready for planting at the end of the season. Thus, at the end of two years, a grafted seedling is produced. This production method is used by tissue culture laboratories and institutions that propagate with cuttings. This production method is currently the most advanced seedling production method in the world. However, the mentioned clonal seedling production method has the following problems/disadvantages;
A grafted seedling is produced in 2 years. This is a long period of time and during these two years, it needs intensive maintenance such as weed control, disease and pest control, fertilization, irrigation, hoeing, cleaning of shoots before grafting, cleaning of bottom shoots after grafting. This process significantly increases the cost of seedling production.
90% of the seedling is cut off with the cut above the graft after grafting, the crown/root balance of the seedling is seriously disrupted, and the seedlings may go into shock due to carbohydrate deficiency in the roots.
This method requires large areas of land, which increases input costs.
The success of grafting of seedlings that are not well cared for decreases and this reduces the number of seedlings with market value.
In this method, since the companies that develop rootstocks and the companies that grow and graft the seedlings are different, the institutions/individuals that purchase these rootstocks have difficulties in finding qualified grafters and the scions of the varieties to be grafted.
Since the 2-year-old grafted seedlings created with this method are long, they take up a lot of space during transfer and high transportation costs occur. In this case, sometimes the cost of shipping the seedlings exceeds the cost of the seedling itself.

Since approximately 70-90% of the roots of 2-year-old bare-rooted seedlings formed with this method remain in the soil during uprooting, the crown/root balance of the seedling is disrupted again. If the crown of the seedlings is not pruned and brought into balance with the root system, all the buds of the seedlings will wake up and form shoots with the start of the season. Since most of the roots of the seedling are cut during uprooting, the existing roots cannot feed the plant and the plant goes into hypovolemic shock. This situation causes seedling losses during the season.

For this reason, a method was needed that would prevent the deficiencies mentioned in the state of the art and enable grafted seedlings to be obtained in a shorter time.

The document numbered CN110810035A can be cited as an example of the state of the art in the literature research. The said document relates to a clonal propagation method for citrus reticulata “chachi”. The said method comprises the following steps; cutting senescent citrus reticulata chachi branches and placing them in a seedbed and transplanting them into a nursery stock bag filled with growing medium after the branch bud and secondary tips have senesced; spraying the seedbed with bactericide; after removing soft shoots, spraying with amino acid foliar fertilizer every two weeks until the first shoots senesce, followed by spraying with foliar fertilizer every two weeks and spreading high nitrogen compound fertilizer between two rows of seedlings and spraying with water until the second shoots senesce; thorough watering of cut seedlings that have senesced a second time, followed by transplanting the seedlings into a seedling bag filled with a growing matrix. However, there is no mention of obtaining grafted seedlings in a short time.

As a result, the existence of the above problems and the inadequacy of the existing solutions, it became necessary to carry out an improvement in the relevant technical field.

### PURPOSE OF THE INVENTION

The present invention relates to a a new seedling production method which eliminates the abovementioned disadvantages and brings new advantages to the relevant technical field.

The main purpose of the invention is to provide a new seedling production method that allows grafted seedlings to be obtained in shorter periods of time such as 7-8 months in the field of fruit and ornamental plants, and does not require large areas.

The purpose of the invention is to provide a method that is applied in narrower areas and during the dormant periods of the plant compared to the methods used in the art; thus, costs arising from weed control, disease and pest control, fertilization, irrigation, hoeing, cleaning of shoots before grafting, cleaning of bottom shoots after grafting, land rent expenses, labor expenses, seedling dismantling, etc. are prevented.

One purpose of the invention is to provide balanced growth of grafted cuttings with the shoot formed after rooting, since no cutting is required/applied.

Another purpose of the invention is to provide high rooting in less area compared to existing methods. With the invention, for example, 30.000 cuttings can be rooted in an area of 10 square meters, and these 30.000 rooted cuttings can be sprouted in a 150 square meter greenhouse.

Another purpose of the invention is to eliminate non-grafted cuttings by grafting on trees and thus prevent the formation of ungrafted seedlings.

Another purpose of the invention is to provide a method that eliminates the need for a grafter and enables the production of directly grafted seedlings.

Another purpose of the invention is to provide small-sized seedlings that take up less space compared to existing grafted seedlings, thus reducing transportation costs.

One purpose of the invention is to provide a method that prevents problems such as crown/root balance being disrupted again due to 80-90% cutting of roots in the technique, seedlings going into hypovalemic shock, and seedling loss.

In order to fulfill the above-described purposes, the invention is a new grafted seedling production method developed to prevent seedling losses and provide a high grafting success rate, and comprises the following process steps;
a) Grafting the rootstock tree at intervals of 10 to 20 cm,
b) Waiting the grafted rootstock tree for 4-5 months,
c) Applying disinfection process to grafted cuttings
d) Immersing the disinfected grafted cutting into rooting hormone and placing the same in a rooting medium and keeping at 60-100% humidity and 7-15 °C temperature until rooting occurs.
e) Obtaining grafted and rooted seedlings by taking the cuttings to the greenhouse or outdoor environment after rooting formation and keeping them until they give shoots.

The structural and characteristic features of the present invention will be understood clearly by the following figures and the detailed description made with reference to these figures. Therefore the evaluation shall be made by taking these figures and the detailed description into consideration.

### FIGURES TO HELP UNDERSTANDING THE INVENTION

FIG. 1: An example schematic representation of the clonal grafted seedling production method in the state of the art. [I. First Stage: Rootstock tree, Il: Second Stage: Placing the non-grafted cuttings in the rooting medium (February 2024); III: Third Stage: Rooted and sprouted seedling (April 2024); IV. Fourth Stage: Grafting process (September/October 2024); V. Fifth Stage: Graft top cut (February 2025); VI. Sixth Stage: Grafted and rooted seedling (December 2025)]

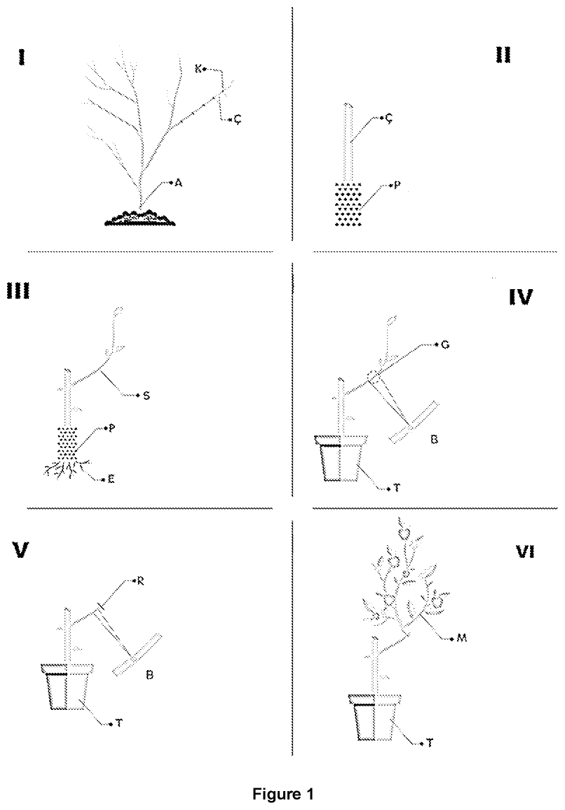

FIG. 2: Representation of an example of the wish tree grafted seedling production method. [1. First Stage: Rootstock tree; 2. Second Stage: Grafting process (September/October 2023); 3.Third Stage: Transferring the Grafted Cutting to the Rooting Medium (February 2024); 4.Fourth Stage: Grafted and rooted seedling (April 2024)]

### DESCRIPTION OF THE PART REFERENCES

A: Rootstock tree
B: Grafted region
Ç: Cutting
D: Grafted Tree
E: Root
G: Grafting eye
K: Cutting site
M: Grafted cultivar
N: Grafted Shoot
P: Rooting medium
R: Top cut
S: Shoot
T: Pot

### Detailed Description of the Invention

In this detailed description, the preferred embodiments of the method of the present invention are described only for clarifying the subject matter in a manner such that no limiting effect is created.

The invention relates to a fast and waste-free grafted seedling production method in the field of fruit and ornamental plants, which prevents seedling losses by producing grafted seedlings without cutting and without disturbing the crown/root balance. The method which is the subject of the invention is also called the wish tree method/wish tree grafted seedling production method in this detailed explanation due to the wish tree appearance of the grafted tree. A new grafted seedling production method developed to reduce the aforementioned seedling losses and provide a high success rate includes the following process steps;
a) Grafting the rootstock tree at intervals of 10 to 20 cm,
b) Waiting for the grafted rootstock tree for 4-5 months,
c) Applying disinfection process to grafted cuttings
d) Immersing the disinfected grafted cutting into rooting hormone and placing the same in a rooting medium and keeping at 60-100% humidity ratios and 7-15 °C temperature until rooting occurs.
e) Obtaining grafted and rooted seedlings by taking the cuttings to the greenhouse or outdoor environment after rooting formation.

In process step a) of the method of the invention, the inoculation process is preferably applied as a stagnant budding.

In process step d) of the method of the invention, the disinfected grafted cuttings are immersed in rooting hormone after scratching and kept in the rooting environment at the appropriate humidity and temperature until rooting occurs.

The rooting environment, which requires moisture and temperature for optimal rooting, is also a suitable environment for fungi and bacteria. For this reason, in the method of the invention, disinfection is applied before rooting the grafted cutting. In the disinfection process, a solution consisting of fungicides and bactericides is prepared and the grafted cuttings are disinfected by immersing them into this solution. The rooting medium is regularly disinfected once a week with dilute solutions of copper hydroxide and copper oxychloride solution.

The scratching process increases the rooting success of the grafted cuttings by increasing the surface area that will form roots for better rooting. In a preferred embodiment of the method according to the invention, a scratching process is applied before rooting to increase the rooting rate.

Since the decrease in humidity in the cuttings will cause the cuttings to dry out, the humidity rate of the environment where the cuttings are located must be higher than the humidity rate within the cuttings. This ratio varies depending on the rooted plants. In the method according to the invention, the grafted cutting is rooted in a rooting medium with a humidity between 60% and 100%. Excess moisture creates a suitable environment for fungi and bacteria to multiply. At this stage, grafted cuttings should be sprayed with fungicides and bactericides once a week.

Temperature and humidity ranges vary depending on the type of cuttings used for rooting. Stone fruits root better at temperatures between 7 and 10 °C, while pome fruits root better at temperatures between 10 and 15 °C. Fruits such as mulberry, olive and fig root better at higher temperatures. The rooting period is generally estimated to be within 40 days, but this rooting period can take up to 90 days.

In the method of the invention, indole butyric acid is preferably used as a rooting hormone to promote rooting, but is not limited to this. The solution prepared at a dose of 2500 ppm was applied to a 2 cm section of the cutting by immersing it for 5 seconds. In plant physiology, in order for plants to continue their lives in a healthy way, their cooling needs must be met and then some temperature total must be formed. With the satisfaction of these needs, the waking mechanism is activated. In the invention, the shoot formation period starts when the temperature exceeds 14 °C, depending on whether the cooling needs of the cuttings taken for rooting are met. Shooting time is generally between 13 and 40 days.

In one embodiment of the inventive method of production of loss-free grafted seedlings, the rootstock tree is grafted at intervals of 10 to 20 cm, and the grafted rootstock tree is kept for 4-5 months. Then, the grafted cutting is disinfected, the disinfected grafted cutting is immersed into the rooting hormone, preferably indole butyric acid, and placed in the rooting medium and kept in a humidity range of 60-100% and a temperature range of 7-15 °C for 40-90 days until rooting occurs. After the rooting formation, grafted and rooted seedlings are obtained by taking the cuttings to the greenhouse or outdoor environment and ensuring that they give shoots preferably between 13 and 40 days.

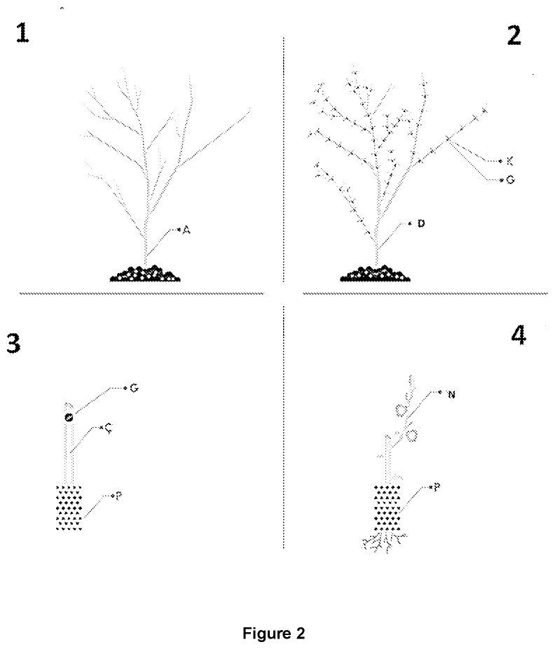

The appearance of a preferred embodiment of the inventive loss-free grafted seedling production method is given in FIG. 2. In this embodiment, all branches of overgrown rootstock trees (A) in the breeding plot or rootstock trees (A) that have reached grafting thickness under nursery conditions are grafted at 10 cm to 20 cm intervals. This grafting process is applied as stagnant budding (G) in the September-October period. When the grafted trees (D) are at rest, the grafted cuttings (C) on the rootstocks are taken and after the necessary disinfection and scratching procedures are applied, they are immersed in rooting hormone and transferred to rooting media (P) in the vials. Here it is kept in suitable humidity and temperature until rooting (E) occurs. This period varies depending on the rooting ability of the rootstock varieties. After the roots (E) are formed, the grafts are taken to the greenhouse or outside to ensure that they produce shoots in a warm environment. Thus, a grafted and rooted seedling is obtained within 7-8 months.

With the method of the present invention, grafting studies of 18 varieties of fruits on 7 rootstocks were carried out in the seedling production facility. The studies conducted are given below.

Vairo, Makako, Lauren, Ferragnes and Ferraduel almond varieties, peach and nectarine were grafted onto the GF 677 rootstock. It has been observed that grafting success is over 95%.

Vairo, Makako, Lauren, Ferragnes and Ferraduel almond varieties, peaches and nectarines were grafted onto the Garnem rootstock. As a result of grafting on this rootstock, the grafting success was observed to be over 95%.

Kulp pear, Deveci pear and Santa Maria pear varieties, Esme quince (Eşme ayva) and Belen hawthorn (belen alici) were grafted onto the BA29 rootstock. It has been observed that grafting success is over 95%.

Granny Smith, Star Krimson, Golden apples were grafted onto the MM111 rootstock. It has been observed that grafting success is over 95%.

Şekerpare apricot, Green plum and Japanese plum were grafted onto the Marianna GF 8-1 rootstock. It has been observed that grafting success is over 95%.

Japanese Plum was grafted onto the Meyrobolan B rootstock. It has been detected that grafting success is over 95%.

0900 Agriculture variety cherry (0900 Ziraat çeşidi kiraz) and Kütahya variety cherry were grafted onto Maxma 14 rootstock and over 95% grafting success was achieved. High grafting success was achieved in this study of grafting 18 fruit varieties onto 7 rootstocks. This high graft success was achieved thanks to the strong rootstocks, their high ability to close the opened wound, and the rapid integration of the grafts. The method in question can be applied to all fruit rootstocks and ornamental plants that can be propagated by cuttings.

In a preferred embodiment of the invention, 4 scratches were made on the rooting zone of the cutting in all directions parallel to the cutting without any scratching on the cuttings of all types related to the scratching process, and thin cuts were made with sharp and sterile knives in the form of removing the skin on both sides of the rooting zone of the grafted cuttings. In our study, it was observed that the hard-seeded species responded positively to the scratches and formed callus better than those that were not scratched. It has been observed that it has less effect on the rooting of soft-seeded plants.

With the current method (clonal production method), a grafted seedling is produced in 2 years. During this period, high costs are incurred due to weed control, disease and pest control, fertilization, irrigation, hoeing, cleaning of shoots before grafting, cleaning of bottom shoots after grafting, land rent expenses, labor expenses, seedling removal, etc. With the method of the present invention, a grafted seedling is produced in 7-8 months. Since this method is applied in narrower areas and during the stagnant period of the plant, it allows the production of seedlings without the need to carry out the above-mentioned procedures, which are costly in the state of the art, thus reducing production costs by 80-90%.

In the state of the art (clonal production method), a large area is needed for production; 30.000 seedlings can be produced in an open area of 5.400 square meters, with a distance of 20 cm in the row and 1 meter between rows. With the method of the present invention, since grafting is done to all branches on the rootstock at intervals of 10 to 20 cm, thousands of grafted Cuttings are obtained on a tree, and these grafted Cuttings are rooted by placing them on shelves in the climate room or in the greenhouse. Rooted grafted cuttings are taken to the greenhouse or outside to sprout. With the method of the present invention, 30.000 cuttings can be rooted in a 10 square meter room and these cuttings can be sprouted in a 150 square meter greenhouse. In the current method of the art (clonal production method), 90% of the seedling is cut off from the top of the grafting eye after grafting, and this disrupts the crown/root balance, preventing the carbohydrates needed by the roots from reaching the roots and causing the seedlings to go into shock. In the method of the invention, no cut is done and balanced growth occurs since the grafted cuttings form shoots after the rooting process is completed.

Since the grafting is done on the tree in the method of the present invention, the cuttings that do not take the graft are eliminated, thus, no ungrafted seedlings are formed. In addition, since directly grafted seedlings are produced; directly grafted seedlings are offered to nurserymen and producers. Since grafted seedlings are small, they take up very little space, thus providing low transportation costs.

1. A grafted seedling production method developed to prevent seedling losses and provide a high grafting success rate, comprising the following steps:
a) grafting a rootstock tree at intervals of 10 to 20 cm;
b) waiting the grafted rootstock tree for 4-5 months;
c) applying a disinfection process to grafted cuttings;
d) immersing the disinfected grafted cutting into rooting hormone and placing the same in a rooting medium and keeping at 60-100% humidity and 7-15 °C temperature until rooting occurs; and
e) obtaining grafted and rooted seedlings by taking the cuttings to the greenhouse or outdoor environment after rooting formation and keeping them until they give shoots.

2. The method of claim 1,
wherein in step a), said grafting process is applied as a stagnant budding.

3. The method of claim 1, wherein in step d), the disinfected grafted cuttings are immersed in rooting hormone after scratching.

4. The method of claim 1,
wherein in step d) the said rooting period is in the range of 40-90 days.

5. The method of claim claim 1, wherein in step e) the said period of shoot formation is between 13 and 40 days.
